(19) United States
(12) Patent Application Publication
(10) Pub. No.: US 2002/0118966 A1
(43) Pub. Date: Aug. 29, 2002

(54) Zoom and focus control system in an optical system

(76) Inventors: Gregory V. Hofer, Loveland, CO (US); David K. Campbell, Loveland, CO (US); Masahiro Ohno, Tokyo (JP); Yoshihiro Yamazaki, Tokyo (JP)

Correspondence Address: HEWLETT-PACKARD COMPANY, Intellectual Property Administration, P.O. Box 272400, Fort Collins, CO, 80527-2400, US

(21) Appl. No.: 09/792,347

(22) Filed: Feb. 23, 2001

(51) Int. Cl. G03B 17/00

(52) U.S. Cl. 396/79

(57) ABSTRACT

An imaging device includes a lens system with a plurality of lenses, and a zoom and focus controller. The lenses include a zoom lens and a focusing lens. The zoom and focus controller controls the positions of the zoom lens and the focusing lens. The zoom and focus controller includes a plurality of focusing curves including a zoom curve and an infinity focusing curve. The zoom and focus controller is responsive to a zoom operation by determining a zoom position of the plurality of lenses, adjusting the focusing lens along the infinity focusing curve for the determined zoom position, and offsetting the focusing lens according to a difference between an actual focusing distance and an infinity focusing distance.

### CROSS-REFERENCE

The present invention is related to subject matter disclosed in the following co-pending patent applications:

1. U.S. patent application entitled, “Zoom and Focus Control Method and System” (HP Docket No. 10006921-1), naming Michelle Ogg, Gregory V. Hofer, and David K. Campbell as inventors and filed on even date herewith; and

2. U.S. patent application entitled, “Brightness Control for Auto-Focus in an Optical System” (HP Docket No. 10006922-1), naming Gregory V. Hofer, David K. Campbell, Masahiro Ohno, and Yoshihiro Yamazaki as inventors and filed on even date herewith.

### BACKGROUND OF THE INVENTION

Electronic imaging devices such as electronic cameras and digital cameras acquire and record images such as still or video images on an electronic storage media. The devices generally include a system for controlling zoom and focus of the image. One type of zoom and focus control system in such cameras is an inner-focus type lens. The inner focus lens gives a suitable zoom imaging capability while reducing size and weight specifications of the camera by eliminating the requirement for a separate zoom lens.

One problem with the inner focus zoom lens is that zooming of the image causes the focal distance of the camera to change. For example, the camera may be accurately focused with respect to a desired image when the operator of the camera actuates a zoom control to increase the size of the image within the image field. The focal distance to the imaged object remains the same, but the zoom operation causes the focal length within the camera to change. The image is no longer accurately focused. Since the focal length is changed without changing the distance from the camera to the imaged object, the zoom lens typically cannot be focused on the imaged object any longer.

Typical digital cameras attempt to focus images in response to zoom changes by a focus-adjusting lens that is moved in a sequence of steps by a mechanical component such as a cam groove when an adjusting zoom ring that alters the focusing position is actuated. One problem is that the mechanical component is a relatively complicated mechanism, increasing complexity and cost of the camera. The mechanical component also increases the weight and volume of the camera.

Various techniques have been used to accurately focus an image during zoom setting changes. In one example, the focusing position shift is adjusted by a mechanical part such as a cam slot. The camera can be automatically adjusted according to information stored in a memory.

In one example (Japanese application 04-3056986), the focal distance of a zoom lens is determined in comparison to a range signal from a range sensor. If the focal distance of the zoom lens is short, then a focusing lens is corrected by reading data from a memory that corresponds to a focus position stored in memory. Also when the focal distance of the zoom lens is short, the focusing position of the focusing lens is corrected by reading data from the memory that corresponds to the most intermediate point of the focusing position stored in memory. The focusing method of the example increases complexity, cost, weight, and size of an imaging system due to the addition of a range finding element.

In another example, (Japanese application 05-3225133), movement of a focal lens is controlled according to the movement speed of a zoom lens. A microcomputer detects when the speed of the zoom lens is varied and responds by reducing focus lens motion in an amount from the information memory that corresponds to the measured value of the zoom lens motion speed. Consequently, inaccuracy in driving control of the focus lens due to measurement errors resulting from the zoom lens motion is reduced, reducing defocusing errors. A problem with the focusing method of the second example is that stored information is required for each lens type and at each focal length, so that a very large memory is necessary to store sufficient control data.

### SUMMARY OF THE INVENTION

What is needed is a zoom and focus control system, and method of operating the zoom and focus control system that facilitate adjustment of focus during image zooming in a vari-focal zoom lens. A zoom and focus control system includes a plurality of stored zoom tables that are accessed to follow zoom and focus curves from a wide zoom position to a tele zoom position, thereby maintaining focus throughout a range of zoom positions.

In accordance with an aspect of the present invention, an imaging device includes a lens system with a plurality of lenses, and a zoom and focus controller. The lenses include a zoom lens and a focusing lens. The zoom and focus controller controls the positions of the zoom lens and the focusing lens. The zoom and focus controller includes a plurality of focusing curves including a zoom curve and an infinity focusing curve. The zoom and focus controller is responsive to a zoom operation by determining a zoom position of the plurality of lenses, adjusting the focusing lens along the infinity focusing curve for the determined zoom position, and offsetting the focusing lens according to a difference between an actual focusing distance and an infinity focusing distance.

In accordance with one aspect of the present invention, a zoom and focus control system for imaging utilizes multiple lenses. In one example, the lenses include a first lens, a second lens, and a third lens. The second and third lenses function as a zoom lens. The second lens alone functions as a focus lens. A storage or memory stores an array of information values designating specific positions for the second lens and the third lens for the zoom values between wide and tele. One set of stored information values is a focus infinity curve that stores a plurality of second lens positions at the plurality of zoom focal length steps that places the lens at a focus distance of infinity. The first set of information stores, for example, motor step position information for the second lens. The first set of information affects the focus of an image. A second set of stored information is a third lens curve that stores motor step position of the third lens at the zoom focal length steps. The second set of values affects both focus and zoom of an image. A third set of stored information is a ratio table that stores a plurality of offset ratio values indicative of offsets from the focus distance at the current position of a lens in comparison to the infinity focus distance.

The zoom focal length steps cover a range from the wide zoom position to the tele zoom position. The offset ratio values relate the change in focus lens position offset, for moving first from the current zoom position to the tele zoom position, then moving from the tele zoom position to a target zoom position.

As the camera is zoomed, the zoom and focus control system measures or otherwise determines the distance of the focus lens from a starting point at a selected zoom position, the infinity objective position. The zoom and focus control system accesses the first stored information set to determine the position on the focus infinity curve for the next zoom focal position. The zoom and focus control system accesses the second stored information to determine the position of the third lens for the zoom focal position. Unless the focus distance is at infinity, the second lens position is offset to adjust to an actual focus distance. The zoom and focus control system accesses the third stored information to adjust focus for actual focus distance.

In accordance with another aspect of the present invention, the zoom and focus control system includes a temperature detector that adjusts focus error resulting from a temperature change.

### BRIEF DESCRIPTION OF THE DRAWINGS

FIG. 1 is a schematic block diagram that illustrates an electronic imaging device that is suitable for implementing a zoom and focus control system in accordance with an embodiment of the present invention.

FIG. 2 is a graph that depicts an example of focus and zoom information that is used to generate a zoom table.

FIG. 3 is a schematic flow chart showing a technique, procedure, or method for focusing an imaging system using a zoom and focus control system.

FIG. 4 is a schematic flow chart that depicts a method or technique for offsetting the lens positions to an actual focal distance.

FIG. 5 is a schematic block diagram that illustrates another electronic camera also suitable for implementing a zoom and focus control system in accordance with an alternative embodiment of the present invention.

### DESCRIPTION OF THE EMBODIMENT(S)

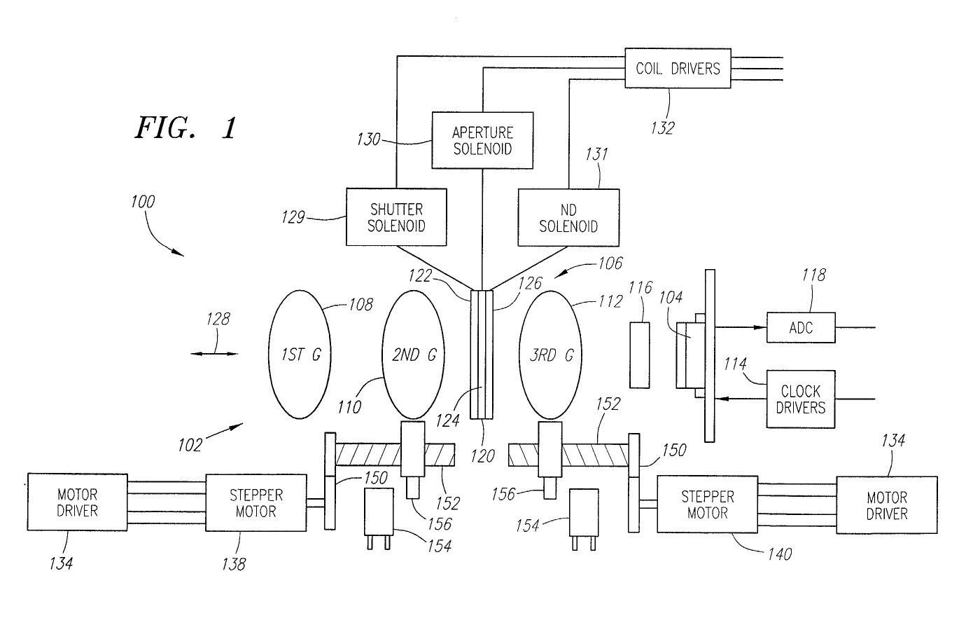

Referring to FIG. 1, a schematic block diagram illustrates an electronic camera 102 that is also suitable for implementing a zoom and focus control system 100 in accordance with an alternative embodiment of the present invention. A sensor such as a charge-coupled device (CCD) photo sensor 104 that detects light passing through a lens system 106 to form an image. The alternative illustrative zoom and focus control system 100 has a lens system 106 that also includes a plurality of lens groups, each of which includes one or more lenses. The present example also has three lens groups, first lens group 108, second lens group 110, and third lens group 112. The first lens group 108 is a fixed-objective lens. The second lens group 110 is a moving group lens that contains an aperture stop (not shown). The second lens group 110 moves in conjunction with the third lens group 112 to cause magnification to change when the lens system 106 moves. The second lens group 110 moves in a nonlinear manner to hold the image plane in a relatively constant position as the lens system 106 is zoomed. The second lens group 110 is also moved to focus the lens system 106 after reaching a particular focal length. The third lens group 112 is also a moving group of lenses in the lens system 106. The third lens group 112 is also a moving lens group. The third lens group 112 moves in a linear manner to change the focal length of the camera as the lens zooms.

The CCD photo sensor 104 is a two-dimensional array of charge-coupled photo sensors that captures an image focused onto the photo sensors by the lens system 106. Individual photo sensor sites are pixels with an associated color such as red, green, or blue. CCD photo sensor 104 is exposed to light and charge integrates at the individual pixel site proportional to the number of photons received at the site. Clock drivers 114 are connected to the CCD photo sensor 104 and convey clock signals to control the readout process of CCD photo sensor 104. Image processing hardware (not shown) generates the clock signals and sends the clock signals from the image processing hardware through the clock drivers 114 to the CCD photo sensor 104. The clock drivers 114 supply clock signals with high current and sufficient frequencies to drive highly capacitive CCD control lines.

A low pass filter 116 is connected to the CCD photo sensor 104 for anti-alias filtering to avoid optical moire effects resulting from the discrete CCD pixel structure. An example of the low pass filter 116 includes two birefringent quartz plates (not shown) and a quarter-wave plate (not shown). One birefringent quart plate produces filtering with respect to a horizontal direction of the CCD array. The other birefringent plate filters in a vertical direction of the CCD array. The quarter-wave plate functions is a depolarizer. The term low-pass filter indicates imaging of only a low spatial frequency image.

The CCD photo sensor 104 generates image signals and passes the signals through an analog to digital converter (ADC) 118 to the image processing hardware. Row-by-row pixel image data from the CCD photo sensor 104 are an analog voltage passed to the analog to digital converter 118. The analog to digital converter 118 amplifies and digitizes the image signal. The digitization process generates an N-bit digital word for each pixel. The analog to digital converter 118 clocks pixel data into the image processing hardware.

A shutter/aperture module 120 is interposed between the second lens group 108 and the third lens group 110. The shutter/aperture module 120 includes a shutter 122, apertures 124, and a neutral density filter 126. The shutter 122 is a blade switched into the optical path 128 of the lens system 106 to prevent light from reaching the CCD photo sensor 104. The shutter 122 blocks light at the end of an exposure time to complete image capture and when the camera is powered off to protect the CCD photo sensor 104 from receiving excessive light and damaging individual sensor elements.

The apertures 124 are multiple blades, each containing a hole. Different blades typically have different diameter holes. Different apertures can be switched into the optical path 128 to reduce the light transmitted through the lens system 106 to the CCD photo sensor 104. Different apertures 124 are used to control light exposure and focus depth of field. A typical still-image electronic camera has one or two aperture blades. In other designs, the aperture 124 may be composed of a diaphragm with continuously variable aperture hole sizes to supply a greater number of selectable apertures.

The neutral density filter 126 is an additional blade that can be switched into the optical path 128. The neutral density filter 126 also reduces the light passed through the lens system 106 to the CCD photo sensor 104. The aperture 124 and the neutral density filter 126 function similarly, but differ in that the neutral density filter 126 can be used to reduce the amount of light passing through the lens system 106 without affecting the focus depth of field. In contrast, usage of an aperture to reduce light to the CCD photo sensor 104 changes the depth of focus. The neutral density filter 126 can be used in conjunction with the apertures 124 to further reduce the level of light passing to the CCD photo sensor 104.

The shutter/aperture module 120 is controlled by signals passed from a camera control element (not shown) via solenoids 130. Individual blades of the shutter 122, the apertures 124, and the neutral density filter 126 are actuated in and out of the lens optical path 128 by a plurality of solenoids including a shutter solenoid 129, an aperture solenoid 130, and a neutral density filter solenoid 131. The solenoids are driven by coil drivers 132 which supply voltage and current for actuating the blades into position in a timely manner. The coil drivers 132 are controlled by signals from a processor (not shown) such as a central processing unit (CPU), a microcontroller, or control logic. The camera control element may be software or firmware that executes on the processor.

The processor determines relative positioning of the second lens group 110, and the third lens group 112, thus controlling zoom and focus functionality. The processor executes application programs that supply control information to a motor driver 134, an executing program code supplying control signals to a first stepper motor 138 and a second stepper motor 140. The stepper motors 138 and 140 physically control the position of the second lens group 110 and the third lens group 112, respectively.

In the illustrative electronic camera 102, the motor driver 134 sends signals to the stepper motor 138 that is connected to the second lens group 110 by gear reduction 150 and a lead screw 152. Similarly, the motor driver 134 sends signals to the stepper motor 138 that is connected to the third lens group 112 also by gear reduction 150 and a lead screw 152. The stepper motors 138 and 140 receive signals from the processor via the motor driver 134 that determine the position and motion of the second lens group 110 and the third lens group 112. In alternative systems, other types of motors and drive mechanisms can be used to controls lens position adjustment of the second and third lens groups 110 and 112. Photo sensors 154 are connected to the motor and drive mechanism for the second and third lens groups 110 and 112 to monitor positioning of the lens groups 110 and 112. The processor determines the initial positions of the second and third lens groups 110 and 112 by moving the lens groups toward the photo sensors 154 and detecting when flag 156 mounted on the second and third lens groups 110 and 112 reaches the photo sensors 154. The position at which the photo sensors 154 detect the flags is a home position. The processor measures the positions of the second and third lens groups 110 and 112 relative to the home position. The processor tracks the number of steps the stepper motors 138 and 140 execute in all moves relative to the home position.

The motor drivers 134 supply voltage and current to the stepper motors 138 and 140, thus determining the position and motion of the second lens group 110 and the third lens group 112. The motor drivers 134 are controlled by signals from the processor.

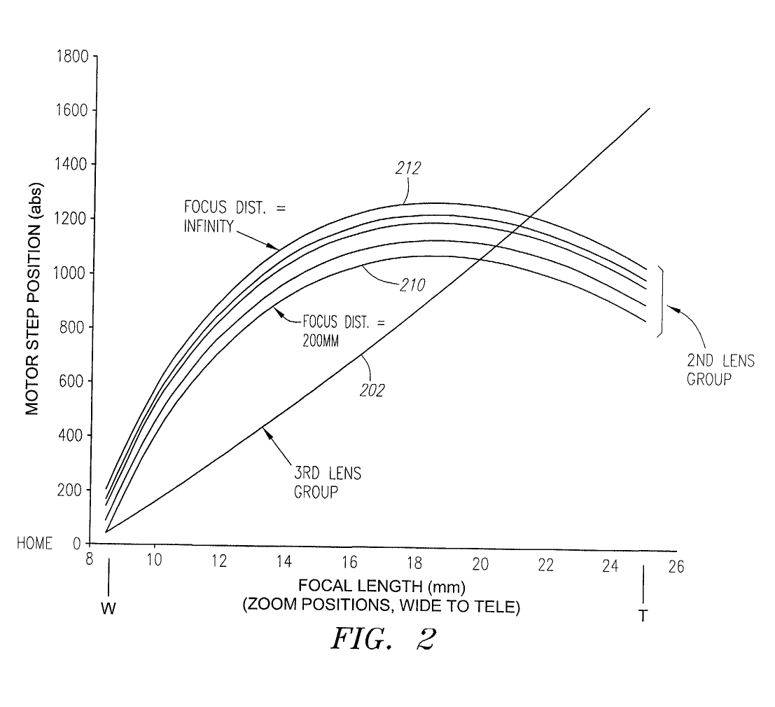

Referring to FIG. 2 in conjunction with FIG. 1, a graph illustrates an example of focus and zoom information that is used to generate a zoom table. The graph shows position changes of the focusing lens group at each zoom position in a range from infinity through 0.2 m of objective distance. The graph shows a plurality of curves designating position of a lens as a function of focal length in millimeters. The focal length relates to zoom position from a wide zoom position (W) to a tele zoom position (T). The plurality of curves include a third lens curve 202, and a plurality of second lens curves that relate to multiple focus distances from a minimum focus distance second lens curve 210 to an infinity distance second lens curve 212. The plurality of second lens curves relate to desired lens positions for a particular focus distances within the range.

The zoom table is a storage or memory within or accessible to the processor that stores an array of information values designating specific positions for the second lens group 110 and the third lens group 112 for zoom values between wide (W) and tele (T). A first set of stored information values is a focus infinity curve that is derived from the infinity distance second lens curve 212 and stores a plurality of second lens group 110 step positions for the stepper motor 138. The first set of stored information encodes motor step positions for a plurality of zoom focal length positions ranging from the wide to tele zoom positions. The first set of motor step positions designates the positions of the second lens group 110 when the focus distance is infinity.

A second set of stored information is a third lens curve that is derived from the third lens curve 202 and stores motor step position of the third lens group 112 at the zoom focal length steps. Position of the third lens group 112 determines the zoom setting of the imaging device.

A third set of stored information is an offset table that stores a plurality of offset values indicative of offsets from the focus distance at the current position of a lens in comparison to the infinity focus distance. The third set of information is derived from offsets of the plurality of second lens curves that relate to multiple focus distances from a minimum focus distance second lens curve 210 to an infinity distance second lens curve 212. The third set of information contains an offset ratio or factor for adjusting the focusing lens, the second lens group 110, when the focus distance is not equal to the infinity focus distance. The third set of information contains a first offset ratio or factor that changes the focus lens position for moving from the current zoom position to the tele zoom position. The third set of information also contains a second offset ratio or factor for changing the focus lens position from the tele zoom position to a target zoom position. The ratios are based on the approximation that, as the focus position changes with focus, the ratio of changes remains essentially constant at the various focal lengths.

Various sizes of tables are possible. In one example, tables that use 50 zoom steps are used.

In an alternative embodiment, the tables may be replaced by polynomial coefficients to reduce the amount of data stored in the electronic camera 102. For example, a computational element such as a processor, logic, controller, or the like can be used to determine the focusing curves as a polynomial approximation.

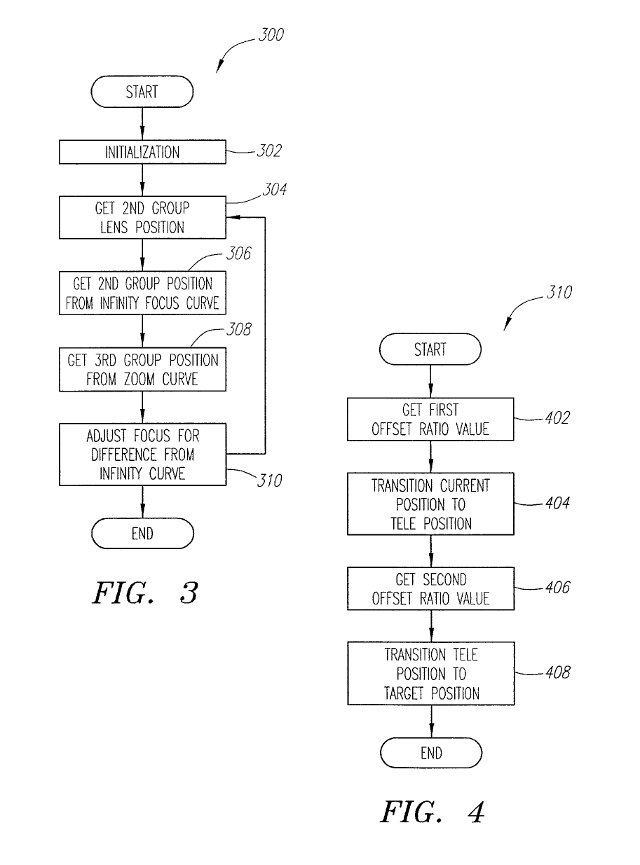

Referring to FIG. 3, a schematic flow chart illustrates a technique, procedure, or method for focusing an imaging system using a zoom and focus control system as depicted in FIG. 1 using tables described according to the graph shown in FIG. 2. A user controls the electronic camera 102 to produce a desired image. In an illustrative example, the first lens group 108 is in a fixed position for all operations. The second lens group 110 and the third lens group 112 perform the zooming operation. The second lens group 110 also performs focusing. The second lens group 110 and third lens group 112 are driven by the stepper motor 138.

A focus and zoom operation 300 is used to maintain focus in the electronic camera 102 when an image is under zoom control. In an initialization operation 302, the photo sensor 154 is used to determine a start position of the second lens group 110 and steps of the stepper motor 138 are counted to subsequently determine the position of the lens. A start position can be predefined for all lens groups. For example, both the second lens group 110 and the third lens group 112 are initialized to a home position during the initialization operation. Initialization 302 is performed once when power is applied to the device. The start position can be adjusted according to measurements from the temperature sensor.

As the electronic camera 102 is zoomed, the position of the second lens group with respect to the starting position is determined 304 when the zoom operation has positioned the second lens group 110 and third lens group 112 at a particular zoom position. The zoom and focus control system accesses the first stored information set 306 to determine the position on the focus infinity curve for the next zoom focal position.

The zoom and focus control system also accesses the second stored information 308 to determine the position of the third lens for the zoom focal position. Unless the focus distance is at infinity, the lens positions are offset to adjust to an actual focus distance 310.

Referring to FIG. 4, a schematic flow chart depicts a method or technique for offsetting the lens positions to an actual focal distance. The zoom and focus control system accesses the third stored information to obtain a first offset value 402. The first offset ratio designates an offset for translating the current second group lens position to the tele zoom position. The zoom and focus control system multiplies the focus offset for the current focusing lens position by the table value to translate to the tele zoom position 404. The zoom and focus control system accesses the third stored information to obtain a second offset ratio value 406. The second offset ratio designates an offset for translating the tele zoom position to a target position. The zoom and focus control system multiplies the focus offset for the tele position by the table value to translate the tele zoom position to the target position 408.

Although in the illustrative examples, the second and third lenses are used for zooming and the second lens is used for focus. In other embodiments, the lenses may be used in a different manner. For example, the first and second lens groups may be used for zooming and the third lens group used for focusing.

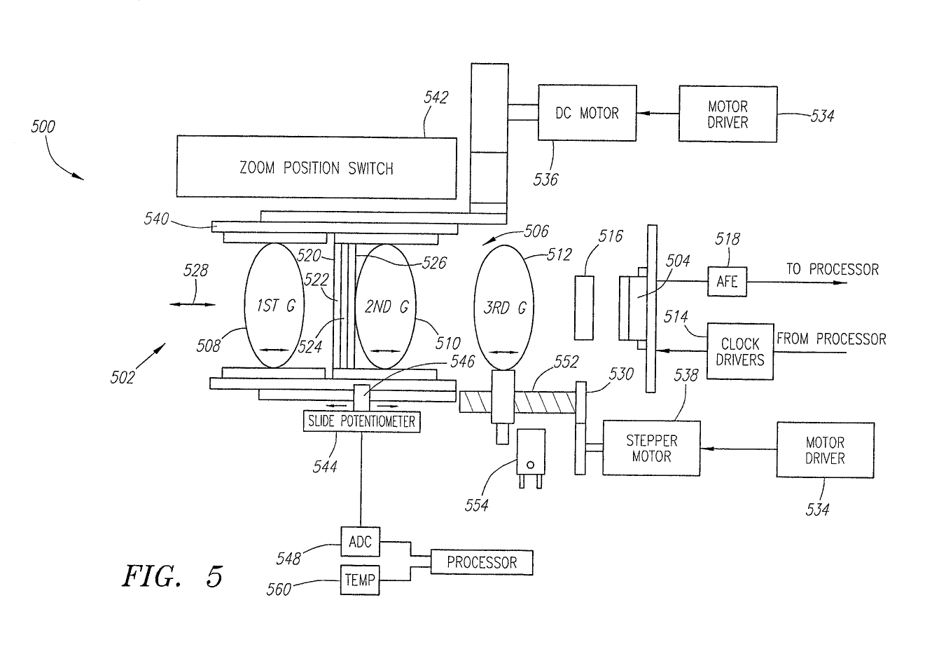

Referring to FIG. 5, a schematic block diagram illustrates another electronic camera 502 that is suitable for implementing a zoom and focus control system 500 in accordance with an embodiment of the present invention. An image is detected at a sensor, for example a charge-coupled device (CCD) photo sensor 504 that detects light passing through a lens system 506. In the illustrative zoom and focus control system 500, the lens system 506 includes a plurality of lens groups, each of which includes one or more lenses. One example has three lens groups, first lens group 508, second lens group 510, and third lens group 512. The second lens group 510, termed a variator, changes the effective focal length of the lens and moves in a linear manner. The first lens group 508 moves in a nonlinear manner relative to the linear motion of the second lens group 510 and functions as a compensator. The first lens group 508 functions to hold the image plane relatively constant as the lens is zoomed over the range of focal lengths of the lens system 506. The third lens group 512 is a positive is a positive element that is moved to focus the lens system 506.

The CCD photo sensor 504 is a two-dimensional array of charge-coupled photo sensors used to capture the image that is focused onto the photo sensors by the lens system 506. The individual photo sensor sites are defined as pixels and have an associated color such as red, green, or blue. As the CCD photo sensor 504 is exposed to light, charge integrates at the individual pixel site proportional to the number of photons received at the site. Clock drivers 514 are connected to the CCD photo sensor 504 and propagate clock signals that are used to control the read-out process of the CCD photo sensor 504. Image processing hardware (not shown) generates the clock signals. The clock signals propagate from the image processing hardware through the clock drivers 514 to the CCD photo sensor 504. The clock drivers 514 supply clock signals with high levels of current at sufficient frequencies to drive highly capacitive CCD control lines.

A low pass filter 516 is connected to the CCD photo sensor 504 for usage as an anti-aliasing filter to avoid optical moire effects that occur due to the discrete nature of the CCD pixel structure. One suitable example of the low pass filter 516 includes two birefringent quartz plates (not shown) and a quarter-wave plate (not shown). One of the birefringent quart plates produces filtering with respect to a horizontal direction of the CCD array. The second birefringent plate produces filtering in a vertical direction of the CCD array, 90° shifted from the horizontal direction. The quarter-wave plate functions as a depolarizer. The term low-pass filter indicates imaging of only a low spatial frequency image.

The CCD photo sensor 504 generates image signals that are passed through an analog to digital converter (ADC) 518 to the image processing hardware. Row-by-row pixel image data is read from the CCD photo sensor 504 as an analog voltage and is passed to the analog to digital converter 518. The analog to digital converter 518 amplifies and digitizes the image signal. The digitization process generates an N-bit digital word for each pixel. The analog to digital converter 518 clocks the digital words for the pixels into the image processing hardware.

A shutter/aperture module 520 is interposed between the first lens group 508 and the second lens group 510. The shutter/aperture module 520 includes a shutter 522, apertures 524, and a neutral density filter 526. The shutter 522 is a blade that is switched into the optical path 528 of the lens system 506 to prevent light from reaching the CCD photo sensor 504. The shutter 522 typically is controlled to block the light at the end of an exposure time to complete image capture. The shutter 522 is also closed when the camera is powered off to protect the CCD photo sensor 504 from receiving excessive light, potentially causing damage to the individual sensor elements.

The apertures 524 are multiple blades containing different diameter holes. An aperture blade can be switched into the optical path 528 to reduce the amount of light transmitted through the lens system 506 to the CCD photo sensor 504. Different apertures 524 are used to control light exposure and to control the focus depth of field. A typical electronic camera that is used for still image reception has one or two aperture blades. Alternatively, the aperture 524 may be composed of a diaphragm with continuously variable aperture hole sizes to supply a greater number of selectable apertures.

The neutral density filter 526 is an additional blade that can be switched into the optical path 528. The neutral density filter 526 also reduces the amount of light that is transmitted through the lens system 506 to the CCD photo sensor 504. Although an aperture 524 and the neutral density filter 526 are similar in function, the neutral density filter 526 can be used to reduce the amount of light passing through the lens system 506 without affecting the focus depth of field. Usage of an aperture to reduce light to the CCD photo sensor 504 always affects the depth of focus. The neutral density filter 526 can be used in conjunction with the apertures 524 to further reduce the level of light passing to the CCD photo sensor 504.

The shutter/aperture module 520 is controlled by signals passed from a camera control block (not shown) via solenoids (not shown). Individual blades of the shutter 522, the apertures 524, and the neutral density filter 526 are actuated in and out of the lens optical path 528 by a solenoid. The individual solenoids are driven by a solenoid driver (not shown) which supplies the voltage and current for actuating the blades into position in a timely manner. The solenoid drivers are controlled by signals from a processor (not shown) such as a central processing unit (CPU), a microcontroller, or control logic. The camera control block may be software or firmware that executes on the processor.

The processor determines relative positioning of the first lens group 508, the second lens group 510, and the third lens group 512, thus controlling zoom and focus functionality. The processor executes application programs that supply control information to a motor driver 534, an executing program code supplying control signals to a DC motor 536 and a stepper motor 538. The DC motor 536 physically controls the position of the first lens group 508 and the second lens group 510 of the lens system 506. The stepper motor 538 physically controls the position of the third lens group 512. The first lens group 508 and the second lens group 510 are held by a lens barrel 540. DC motor 536 is connected to the lens barrel 540 and drives the rotation of the lens barrel 540 via a set of gears (not shown) between the lens barrel 540 and the DC motor 536. As the lens barrel 540 rotates, the positions of the first lens group 508 and the second lens group 510 are adjusted through the operation of cam slots (not shown) inside the lens barrel 540. A lens cam switch 542 is mounted on the lens barrel 540 and sends signal transitions to the processor as the lens barrel 540 rotates through a plurality of zoom positions. In one example, the electronic camera 502 has three zoom positions of wide, tele, and retract. A slider potentiometer 544 is connected to the lens barrel 540. As the lens barrel 540 rotates between the wide and tele zoom positions, the slider potentiometer 544 produces a fine zoom position information. A cam slot 546 in the lens barrel 540 drives the slider potentiometer 544 depending on the position of the wide and tele zoom position. The processor determines the fine zoom position by reading the voltage obtained from the center tap of the slider potentiometer 544 via an analog-to-digital converter (ADC) 548. Fine zoom position values produced by the slider potentiometer 544 are calibrated by recording the slider potentiometer values when the lens cam switch 542 is positioned at the tele and wide positions.

In the illustrative electronic camera 502, the motor driver 534 sends signals to the stepper motor 538 that is connected to the third lens group 512 by gear reduction 550 and a lead screw 552. The stepper motor 538 receives signals from the processor via the motor driver 534 that determine the position and motion of the third lens group 512. In alternative systems, other types of motors and drive mechanisms can be used to controls lens position adjustment of the third lens group 512. Photo sensors 554 are connected to the motor and drive mechanism for the third lens group 512 to monitor positioning of the third lens group 512. The processor determines the initial position of the third lens group 512 by moving the lens group toward the photo sensor 554 and detecting when flag 562 mounted on the third lens group 512 reaches the photo sensor 554. The position at which the photo sensor 554 detects the flag is a home position. The processor measures the position of the third lens group 512 relative to the home position. The processor tracks the number of steps the stepper motor 538 executes in all moves relative to the home position.

The motor driver 534 supplies voltage and current to the DC motor 536 and the stepper motor 538, thus determining the position and motion of the first lens group 508 and second lens group 510, and the third lens group 512. The motor driver 534 is controlled by signals from the processor.

A temperature sensor 560 inside the electronic camera 502 measures temperature and is connected to the processor. The processor includes a processing logic that is capable of adjusting a starting position of the lenses to adjust focus for temperature differences.

While the invention has been described with reference to various embodiments, it will be understood that these embodiments are illustrative and that the scope of the invention is not limited to them. Many variations, modifications, additions and improvements of the embodiments described are possible. For example, those having ordinary skill in the art will readily implement the steps necessary to provide the structures and methods disclosed herein, and will understand that the process parameters, materials, and dimensions are given by way of example only and can be varied to achieve the desired structure as well as modifications which are within the scope of the invention. Variations and modifications of the embodiments disclosed herein may be made based on the description set forth herein, without departing from the scope and spirit of the invention as set forth in the following claims. For example, one or ordinary skill in the art could similarly apply the first and second quality-of-service techniques to the other interconnect structures described herein.

In the claims, unless otherwise indicated the article “a” is to refer to “one or more than one”.

What is claimed is:

1. An imaging device comprising:
a lens system comprising a plurality of lenses, the lenses including a zoom lens and a focusing lens; and
a zoom and focus controller that controls the positions of the zoom lens and the focusing lens, the zoom and focus controller including a plurality of focusing curves including a zoom curve and an infinity focusing curve, the zoom and focus controller being responsive to a zoom operation by determining a zoom position of the plurality of lenses, adjusting the focusing lens along the infinity focusing curve for the determined zoom position, and offsetting the focusing lens according to a difference between an actual focusing distance and an infinity focusing distance.

2. An imaging device according to claim 1 further comprising:
a memory for storing the focusing curves, the memory including a plurality of ratio values indicative of a distance ratio from a fixed position of the focusing lens at a plurality of zoom positions.

3. An imaging device according to claim 1 further comprising:
a memory for storing the focusing curves, the memory including:
a first set of stored information values in a focus infinity curve that stores a plurality of focusing lens positions at the plurality of zoom focal length steps for a predetermined and specified objective position, the first set of stored information values affecting zoom and focus of an image;
a second set of stored information values in a zoom curve that stores a plurality of zoom lens positions at the plurality of zoom focal length steps; and
a third set of stored information values in a ratio table including a plurality of ratio values indicative of a distance ratio from a fixed position of the focusing lens at a plurality of zoom positions.

4. An imaging device according to claim 1 further comprising:
a memory for storing the focusing curves, the memory including:
a first set of stored information values in a focus infinity curve that stores a plurality of focusing lens positions at the plurality of zoom focal length steps for a predetermined and specified objective position, the first set of stored information values affecting zoom and focus of an image;
a second set of stored information values in a zoom curve that stores a plurality of zoom lens positions at the plurality of zoom focal length steps; and
a third set of stored information values in a ratio table including a plurality of ratio values indicative of a distance ratio from a fixed position of the focusing lens at a plurality of zoom positions, the third set of stored information values including a set of ratios for transitioning from a current zoom position to a tele zoom position and a set of ratios for transitioning from the tele zoom position to a target zoom position.

5. An imaging device according to claim 1 further comprising:
a sensor that measures movement of one or more of the lenses from a starting point of a specified zoom position;
a stepper motor; and
a controller for determining and controlling position of one or more of the lenses based on the starting point and steps of motion by the stepper motor.

6. An imaging device according to claim 1 further comprising:
a computational element that determines the focusing curves as a polynomial approximation.

7. An imaging device according to claim 1 further comprising:
a temperature detector coupled to the lens system, the temperature detector for detecting temperature within the imaging device and for offsetting the focusing lens position based on the temperature.

8. An imaging device according to claim 1 further comprising:
a fixed objective lens included in the lens system.

9. An imaging device according to claim 1 further comprising:
an image sensor coupled to the lens system.

10. An imaging device according to claim 1 further comprising:
a control process operational in the controller, the control process including:
a processing logic capable of determining distance of the focusing lens from a starting point at a selected zoom position;
a processing logic capable of accessing the infinity focusing curve to determine a position on the focus infinity curve for a next zoom focal position;
a processing logic capable of accessing a second stored information to determine a position of the zoom lens for the zoom focal position; and
a processing logic capable of accessing a third stored information to offset focusing for an actual focus distance.

11. An imaging device according to claim 10 further comprising:
a processing logic capable of translating the current lens position to the tele zoom position according to the third stored information; and
a processing logic capable of translating the tele zoom position to a target position.

12. An imaging device according to claim 10 further comprising:
a processing logic capable of moving the focusing lens and the zoom lens relative to respective starting points.

13. An imaging device according to claim 10 further comprising:
a temperature detector coupled to the lens system, the temperature detector for detecting temperature within the imaging device and for offsetting the focusing lens position based on the temperature; and
a processing logic capable of adjusting respective starting points of the focusing lens and the zoom lens according to a measurement from the temperature detector.

14. A control process executable in an imaging device that includes a lens system with a focusing lens and a zoom lens, and a zoom and focus controller, the control process comprising:
a processing logic capable of determining distance of the focusing lens from a starting point at a selected zoom position;
a processing logic capable of accessing the infinity focusing curve to determine a position on the focus infinity curve for a next zoom focal position;
a processing logic capable of accessing a second stored information to determine a position of the zoom lens for the zoom focal position; and
a processing logic capable of accessing a third stored information to offset focusing for an actual focus distance.

15. A control process according to claim 14 further comprising:
a processing logic capable of translating the current lens position to the tele zoom position according to the third stored information; and
a processing logic capable of translating the tele zoom position to a target position.

16. A control process according to claim 14 further comprising:
a processing logic capable of moving the focusing lens and the zoom lens relative to respective starting points.

17. A control process according to claim 14 further comprising:
a temperature detector coupled to the lens system, the temperature detector for detecting temperature within the imaging device and for offsetting the focusing lens position based on the temperature; and
a processing logic capable of adjusting respective starting points of the focusing lens and the zoom lens according to a measurement from the temperature detector.

18. A method of controlling zoom and focus in an imaging device that includes a lens system with a focusing lens and a zoom lens, and a zoom and focus controller, the method comprising:
determining distance of the focusing lens from a starting point at a selected zoom position;
accessing the infinity focusing curve to determine a position on the focus infinity curve for a next zoom focal position;
accessing a second stored information to determine a position of the zoom lens for the zoom focal position; and
accessing a third stored information to offset focusing for an actual focus distance.

19. A method according to claim 18 further comprising:
translating the current lens position to the tele zoom position according to the third stored information; and
translating the tele zoom position to a target position.

20. A method according to claim 18 further comprising:
moving the focusing lens and the zoom lens relative to respective starting points.

21. A method according to claim 18 further comprising:
detecting temperature within the imaging device and for offsetting the focusing lens position based on the temperature; and
adjusting respective starting points of the focusing lens and the zoom lens according to a measurement from the temperature detector.
